(19) United States
(12) Patent Application Publication
(10) Pub. No.: US 2024/0394856 A1
(43) Pub. Date: Nov. 28, 2024

(54) MAPPING FUNCTION EXTRACTION SYSTEM, MAPPING FUNCTION EXTRACTION METHOD, DISPLAY DEVICE, AND COMPUTER-READABLE MEDIUM

(71) Applicant: SAMSUNG DISPLAY CO., LTD., Yongin-si (KR)

(72) Inventors: SANG HO KIM, Yongin-si (KR); SOO MIN BAEK, Yongin-si (KR); JU YOUN SON, Yongin-si (KR); JI WON LEE, Yongin-si (KR); CHEON MYEONG LEE, Yongin-si (KR); BAEK HYEON LIM, Yongin-si (KR); JU HWA HA, Yongin-si (KR)

(21) Appl. No.: 18/603,275

(22) Filed: Mar. 13, 2024

(30) Foreign Application Priority Data
May 24, 2023 (KR) 10-2023-0067082

(51) Int. Cl. G06T 5/80; G02B 3/00; G06T 7/00; G06T 7/73; G09G 3/00

(52) U.S. Cl. CPC G06T 5/80; G02B 3/0037; G06T 7/0002; G06T 7/74; G09G 3/001; G09G 2320/06

(57) ABSTRACT

A mapping function extraction system includes a scan unit for generating appearance data of a multi-channel lens by scanning the multi-channel lens, a comparison unit for generating correction data by comparing the appearance data with pre-stored standard appearance data, and an extraction unit for generating a mapping function by applying the correction data to a pre-stored standard mapping function.

### CROSS-REFERENCE TO RELATED APPLICATION

This application claims priority to and benefit of Korean Patent Application No. 10-2023-0067082, filed May 24, 2023, which is hereby incorporated by reference in its entirety.

### 1. TECHNICAL FIELD

One or more embodiments described herein relate to a mapping function extraction system, a mapping function extraction method, and a display device.

### 2. RELATED ART

Electronic devices containing displays have been designed to be worn on human bodies. These electronic devices are generally referred to as wearable devices and serve to improve the convenience, portability, and accessibility of users. A head-mounted display (or head-mounted electronic device (HMD)) is one example of a wearable electronic device. The HMD may provide a virtual reality (VR) image by enlarging a source image through a lens.

### SUMMARY

Embodiments provide a mapping function extraction system and a mapping function extraction method, which can rapidly extract a mapping function for preventing distortion of an image, such as but not limited to a VR image.

Embodiments also provide a display device capable of reducing the time of a mapping process, by using the above-described mapping function and effectively preventing distortion of a VR image.

In accordance with one embodiment of the present invention, there is provided a mapping function extraction system including: a scan unit (or scanner) configured to generate appearance data of a multi-channel lens by scanning the multi-channel lens; a comparison unit (or comparator) configured to generate correction data by comparing the appearance data with pre-stored standard appearance data; and an extraction unit (or extractor) configured to generate a mapping function by applying the correction data to a pre-stored standard mapping function.

The multi-channel lens may include a plurality of sub-lenses through which light emitted from a display member passes.

The appearance data may include appearance information of a recessed part formed by the plurality of sub-lenses.

The standard appearance data may include appearance information of the multi-channel lens having an ideal design.

The correction data may be derived from a difference between the standard appearance data and the appearance data.

The standard mapping function may be a function for calculating position information of pixels corresponding to a VR image to be provided through the multi-channel lens having an ideal design.

The mapping function may be extracted corresponding to a change in the appearance data.

In accordance with one embodiment of the present invention, there is provided a mapping function extraction method including: generating appearance data of a multi-channel lens by scanning the multi-channel lens; generating correction data by comparing the appearance data with pre-stored standard appearance data; and extracting a mapping function by applying the correction data to a pre-stored standard mapping function.

The multi-channel lens may include a plurality of sub-lenses through which light emitted from a display member passes.

The appearance data may include appearance information of a recessed part formed by the plurality of sub-lenses.

The standard appearance data may include appearance information of the multi-channel lens having an ideal design.

The correction data may be derived from a difference between the standard appearance data and the appearance data.

The standard mapping function may be a function for calculating position information of pixels corresponding to a VR image to be provided through the multi-channel lens having an ideal design.

The mapping function may be extracted corresponding to a change in the appearance data.

In accordance with one embodiment of the present invention, there is provided a display device including: a display unit (or display) including pixels; a lens unit (or lens arrangement) including at least one multi-channel lens configured to provide a VR image by refracting and reflecting an image displayed on the display unit; and a control unit (or controller) configured to generate mapping data including position information of the pixels corresponding to the VR image, based on a pre-stored mapping function and VR image data, wherein a difference value between standard appearance data of the multi-channel lens and appearance data of the multi-channel lens is applied to the mapping function.

The mapping function may be extracted corresponding to a change in the appearance data.

The standard appearance data may include appearance information of the multi-channel lens having an ideal design.

The appearance data may include appearance information of the multi-channel lens through scanning.

The appearance data may include appearance information of a recessed part formed by a plurality of sub-lenses included in the multi-channel lens.

The control unit may provide the mapping data to the display unit. The display unit may display the image, based on the mapping data.

In accordance with one or more embodiments, a computer-readable medium storing instructions which, when executed by at least one processor, causes the at least one processor to: generate appearance data of a multi-channel lens by scanning the multi-channel lens; generate correction data by comparing the appearance data with pre-stored standard appearance data; and generate a mapping function by applying the correction data to a pre-stored standard mapping function.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a mapping function extraction system in accordance with an embodiment of the present disclosure.

FIGS. 2 and 3 are views illustrating a multi-channel lens in accordance with an embodiment of the present invention.

FIG. 4 is a view illustrating a mapping process in accordance with an embodiment of the present invention.

FIG. 5 is a flowchart illustrating a mapping function extraction method in accordance with an embodiment of the present invention.

FIG. 6 is a perspective view of a display device in accordance with an embodiment of the present invention.

FIG. 7 is a plan view of a display device in accordance with an embodiment of the present invention.

FIG. 8 is a side view of a portion of a display device in accordance with an embodiment of the present invention.

FIG. 9 is a block diagram illustrating a display device in accordance with an embodiment of the present invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In describing the drawings, like reference numerals have been used for like elements. In the accompanying drawings, the dimensions of the structures are enlarged than the actual size in order to clearly explain the invention. It will be understood that, although the terms “first”, “second”, etc. may be used herein to describe various elements, these elements should not be limited by these terms. These terms are only used to distinguish one element from another element. For instance, a first element discussed below could be termed a second element without departing from the scope of the invention. Similarly, the second element could also be termed the first element.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the following description, when a first part is “connected” to a second part, this includes not only the case where the first part is directly connected to the second part, but also the case where a third part is interposed therebetween and they are connected to each other.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

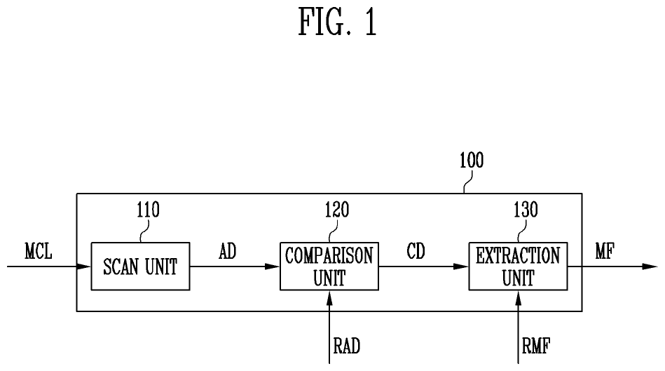

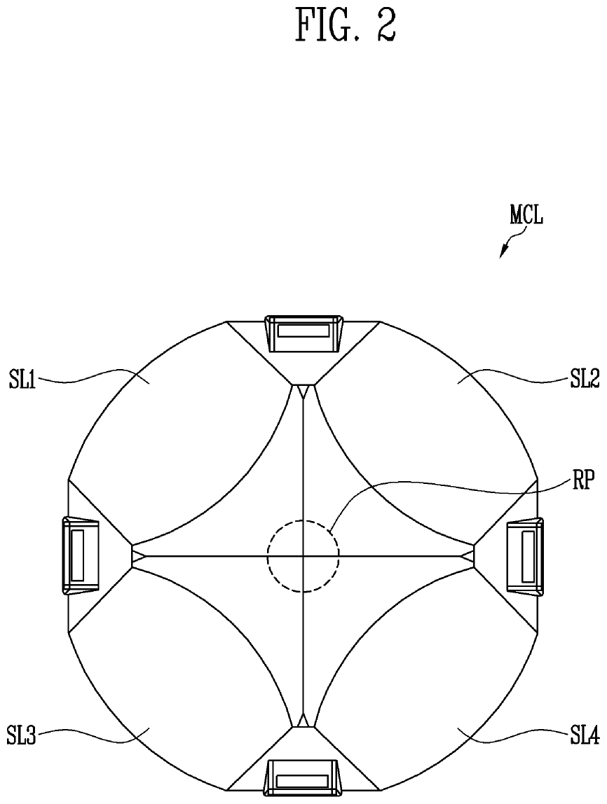

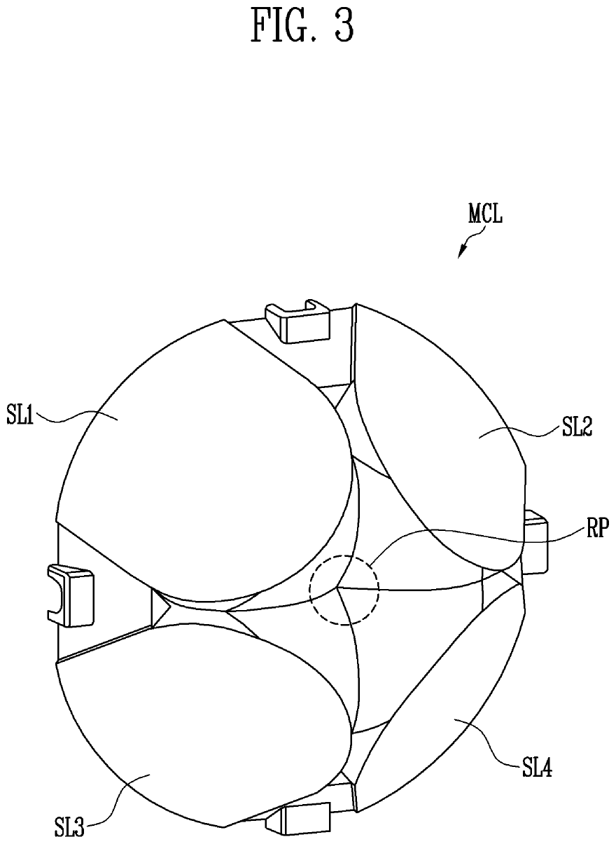

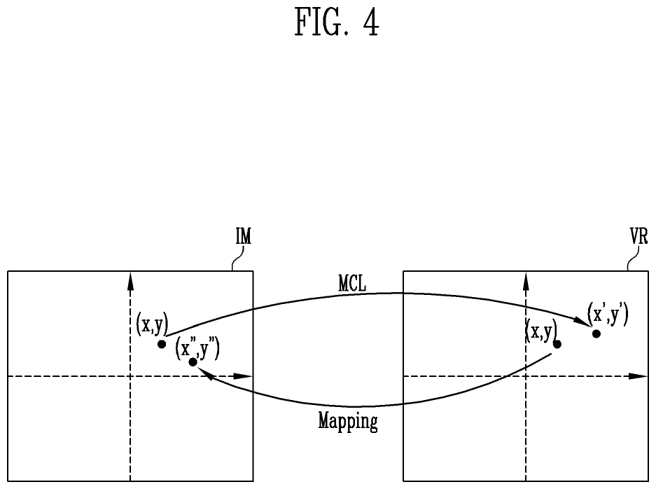

FIG. 1 is a block diagram illustrating a mapping function extraction system 100 in accordance with an embodiment of the present invention. FIGS. 2 and 3 are views illustrating a multi-channel lens MCL in accordance with an embodiment of the present invention. FIG. 4 is a view illustrating a mapping process in accordance with an embodiment of the present invention.

Referring to FIG. 1, the mapping function extraction system 100 may include a scan unit (or scanner) 110, a comparison unit (or comparator) 120, and an extraction unit (or extractor) 130.

The scan unit 110 may scan the multi-channel lens MCL. To this end, the multi-channel lens MCL may be provided to the scan unit 110. Referring to FIGS. 2 and 3, the multi-channel lens MCL may include a plurality of sub-lenses. For example, the multi-channel lens MCL may include four sub-lenses SL1, SL2, SL3, and SL4. Each of the four sub-lenses SL1, SL2, SL3, and SL4 may have a shape including a curved surface. However, the number and shape of sub-lenses included in the multi-channel lens MCL are not limited to four as in the case in the above-described example.

The scan unit 110 may include a 3D scanner for three-dimensionally scanning the multi-channel lens MCL. For example, the 3D scanner may include a contact 3D scanner or a non-contact 3D scanner. The non-contact 3D scanner may include a 3D laser scanner using a predetermined method such as an optical triangulation method, a 3D scanner using a white light method, a 3D scanner using a modulated light method, and the like. However, the 3D scanner included in the scan unit 110 is not limited to the above-described example and may use a different method in other embodiments.

The scan unit 110 may generate appearance data AD of the multi-channel lens MCL by scanning the multi-channel lens MCL. The appearance data AD may include physical information associated with an appearance of the multi-channel lens MCL (hereinafter, referred to as appearance information). For example, appearance data AD may include appearance information on a curvature, a surface profile (or surface roughness), a volume, and the like of the multi-channel lens MCL. The scan unit 110 may provide the appearance data AD to the comparison unit 120.

Referring to FIGS. 2 and 3, in an embodiment, the appearance data AD may include appearance information of a recessed part RP formed by the plurality of sub-lenses SL1, SL2, SL3, and SL4 included in the multi-channel lens MCL. The recessed part RP may be a depressed part formed in an area in which the plurality of sub-lenses SL1, SL2, SL3, and SL4 intersect or are in contact with each other. Distortion of a VR image VR (e.g., see FIG. 4) may be deepened due to interference between the plurality of sub-lenses SL1, SL2, SL3, and SL4 at the recessed part RP. Therefore, in order to effectively prevent distortion of the VR image VR, the appearance data AD may include appearance information of the recessed part RP.

The comparison unit 120 may compare the appearance data AD of the multi-channel lens MCL with predetermined, reference or standard appearance data RAD. To this end, the standard appearance data RAD may be provided to the comparison unit 120. In one embodiment (discussed in greater detail below), the standard appearance data RAD may be pre-stored in the comparison unit 120.

The standard appearance data RAD may include appearance information of the multi-channel lens MCL that corresponds to a predetermined design, such as but not limited to an ideal design. For example, the standard appearance data RAD may include appearance information of a multi-channel lens MCL that is manufactured through injection molding. A tolerance may occur between the appearance data AD and the standard appearance data RAD due to defects in or other aspects taken into consideration during a manufacturing process of the multi-channel lens MCL, or the like. This tolerance may translate into distortions in the virtual image and may be corrected using embodiments described herein.

The comparison unit 120 may generate correction data CD by comparing the appearance data AD with the standard appearance data RAD. For example, the comparison unit 120 may process, in data form, the above-described tolerance occurring between the appearance data AD and the standard appearance data RAD. Accordingly, the correction data CD may include or be based on information on the tolerance occurring between the appearance data AD and the standard appearance data RAD. For example, the correction data CD may be derived from or based on a difference between the standard appearance data RAD and the appearance data AD. The comparison unit 120 may provide the correction data CD to the extraction unit 130.

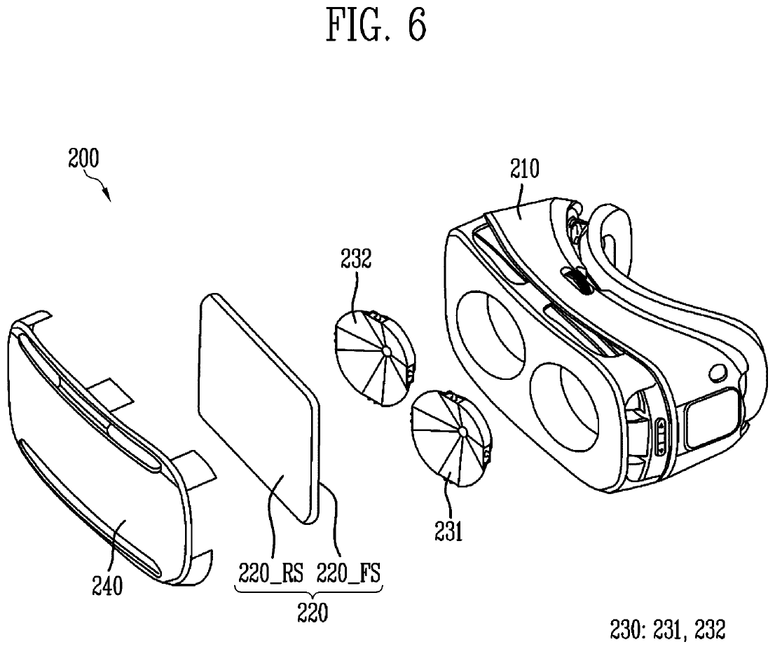

Referring to FIG. 4, an image IM displayed on a display member (e.g., display 220 in FIG. 6) may be converted into a virtual reality image VR while passing through the multi-channel lens MCL. In this process, distortion of the VR image VR may occur based, for example, on the tolerance described above. For example, a pixel located at a coordinate position (x, y) in the image IM may be shifted or realigned to a coordinate position (x′, y′) in the VR image VR through the multi-channel lens MCL. As a result, distortion of the VR image VR may occur.

In order to prevent this distortion of the VR image VR, a process of extracting a correction function may be performed. This process may include locating the pixel at a coordinate position (x, y) in the VR image VR and then changing (or mapping) the position of the pixel in the image IM to a coordinate position (x″, y″), which corresponds (due to the tolerance) to the pixel at coordinate position (x,y) in the VR image VR. This mapping may be performed using the extracted correction function. Thus, this process may be referred to as a mapping process, and the correction function may be referred to as a mapping function.

The extraction unit 130 may extract the mapping (or correction) function MF by applying the correction data CD to a standard mapping function RMF. For example, the extraction unit 130 may extract the mapping function MF by applying, to the standard mapping function RMF, the tolerance between the appearance data AD of the multi-channel lens MCL and the standard appearance data RAD. To this end, the standard mapping function RMF may be provided to the extraction unit 130 as shown in FIG. 1. In one embodiment, the standard mapping function RMF may be pre-stored in the extraction unit 130.

The standard mapping function RMF may be a correction function for calculating position information of pixels corresponding to a VR image to be provided through an ideal design of the multi-channel lens MCL. For example, the standard mapping function RMF may be a correction function used in the above-described mapping process so as to prevent distortion of the VR image VR due to the multi-channel lens MCL having an ideal design. The standard mapping function RMF may be pre-derived in an initial design process of the multi-channel lens MCL.

In one embodiment, the mapping function MF may be a correction function for calculating position information of pixels corresponding to a VR image VR when the image IM is provided through an actually designed multi-channel lens MCL. For example, the mapping function MF may be a correction function used in the above-described mapping process to prevent distortion of the VR image VR due to an actually designed multi-channel lens MCL manufactured through injection molding. The mapping function MF may be extracted corresponding to a change in the appearance data AD due to defects in the manufacturing process of the multi-channel lens MCL, or the like.

As described above, the process of extracting the correction function (i.e., the mapping function MF) is to performed beforehand in order to prevent distortion of the VR image VR. In an example, the mapping function MF may be extracted by acquiring position information of pixels through photographing of the image IM and the VR image VR and deriving, in a function form, a realignment characteristic of the pixels according to a characteristic of the multi-channel lens MCL. In the above-described process, photographing at various viewpoints is performed by considering a gaze direction of a user. As a result, significant time may be expended during this process. In addition, the process of deriving the realignment characteristic of the pixels (according to the characteristic of the multi-channel lens MCL) from the position information of the pixels is complicated. Therefore, the mapping function MF may not be easily extracted.

On the other hand, in the mapping function extraction system 100 in accordance with the embodiment of the present disclosure, the appearance information of the multi-channel lens MCL can be easily acquired through scanning, and the mapping function MF obtained by considering the appearance information of the multi-channel lens MCL can be rapidly extracted based on the standard appearance data RAD and the standard mapping function RMF, which are pre-derived. Further, since the mapping function MF in accordance with the embodiment of the present disclosure is extracted by reflecting the tolerance between the appearance data AD of the multi-channel lens MCL and the standard appearance data RAD, distortion of the VR image VR according to the characteristic of the multi-channel lens MCL can be more accurately corrected.

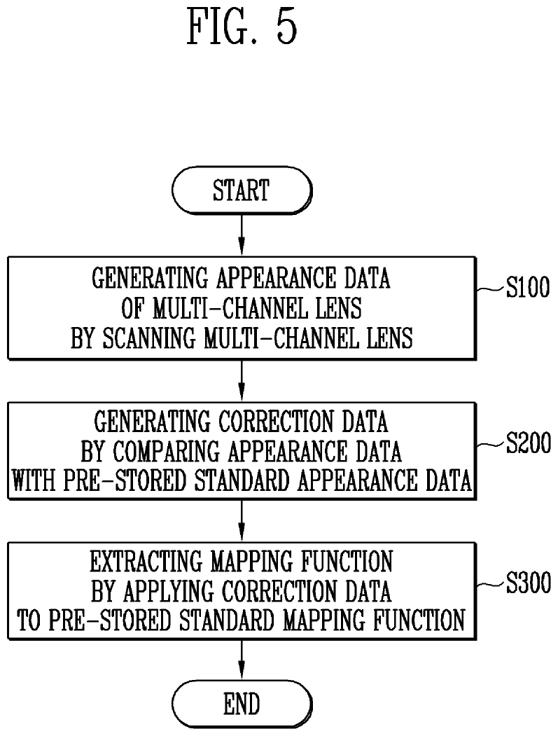

FIG. 5 is a flowchart illustrating a mapping function extraction method in accordance with an embodiment of the present invention. In relation to FIG. 5, descriptions of portions overlapping with those described above will be omitted or simplified.

Referring to FIGS. 1 and 5, first, appearance data AD of a multi-channel lens MCL may be generated by scanning the multi-channel lens MCL (S100). Operation S100 may include a process of extracting actual appearance information of the multi-channel lens MCL (e.g., manufactured through injection molding) by performing 3D scanning.

Next, correction data CD may be generated by comparing the appearance data AD with pre-stored standard appearance data RAD (S200). Operation S200 may include a process of deriving a tolerance by comparing the actual appearance information of the multi-channel lens MCL (e.g., manufactured through the injection molding) with predetermined or reference (e.g., ideal) appearance information of the multi-channel lens MCL according to an initial design value.

Next, a mapping function MF may be extracted by applying the correction data CD to a pre-stored standard mapping function RMF (S300). Operation S300 may include a process of extracting a correction function for preventing distortion of a VR image VR (e.g., see FIG. 4). This may be performed by reflecting the actual appearance information on the standard mapping function RMF, which has been pre-derived according to the ideal appearance information of the multi-channel lens MCL. As described below, the mapping function MF may then used to reduce distortion in the virtual image.

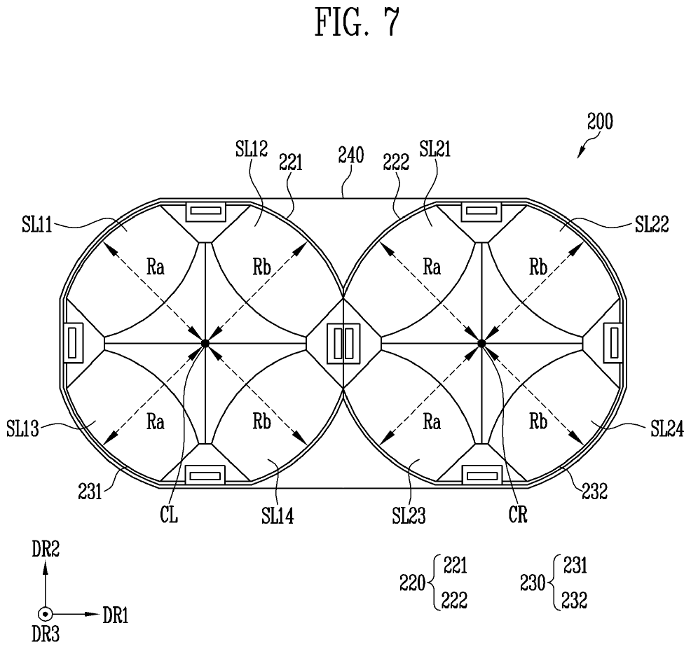

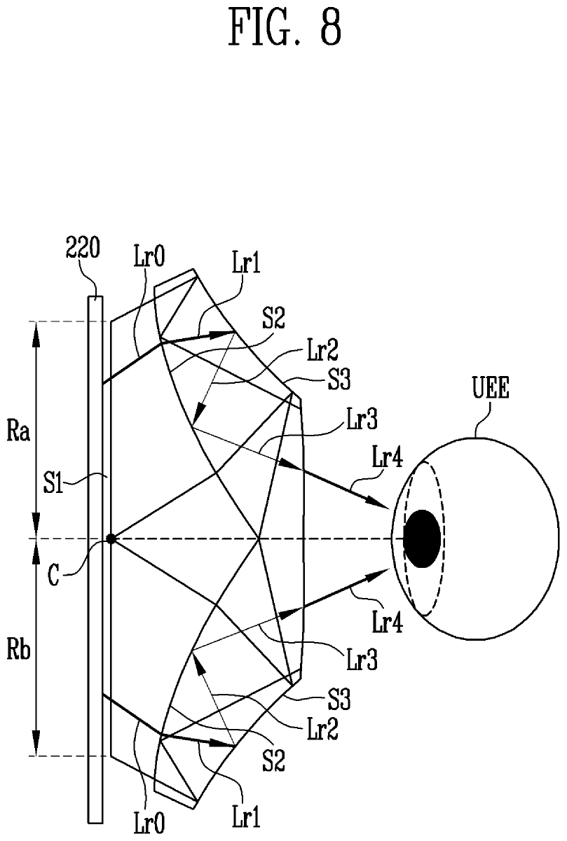

FIG. 6 is a perspective view of a display device 200 in accordance with an embodiment of the present invention. FIG. 7 is a plan view of a display device 200 in accordance with an embodiment of the present invention. FIG. 8 is a side view of a portion of a display device 200 in accordance with an embodiment of the present invention.

Referring to FIG. 6, the display device 200 may include a head-mounted display device worn on a head of a user to provide the user with a screen on which an image is displayed. The head-mounted display device may be a see-through type or a see-closed type. In a see-through type, augmented reality (AR) is provided based on actual external objects. In a see-closed type, virtual reality (VR) is provided to the user through a screen independent from external objects. Hereinafter, the head-mounted display device of the see-closed type is exemplified, but the present disclosure is not limited thereto.

The display device 200 may include a main frame 210, a display unit (or display) 220, a lens unit (or lens arrangement) 230, and a cover frame 240. The main frame 210 may be worn on the face of the user. The main frame 210 may have a shape corresponding to a shape of the head (face) of the user. The lens unit 230, the display unit 220, and the cover frame 240 may be mounted in the main frame 210.

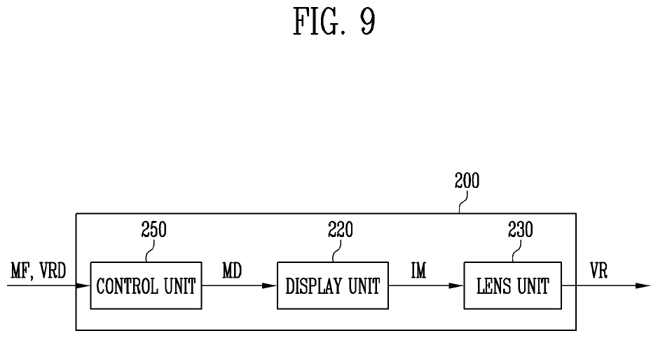

The main frame 210 may include a space or a structure for accommodating the display unit 220 and the lens unit 230. The main frame 210 may further include a structure (e.g., a strap or a band) which facilitates mounting thereof on the head of the user. A control unit 250 (e.g., see FIG. 9), an image processing unit, a lens accommodating unit, and the like may be further mounted in the main frame 210.

The display unit 220 may display an image. In one embodiment, the display unit 220 may include a front surface 220_FS on which the image is displayed and a rear surface 220_RS opposite to the front surface 220_FS. In the display unit 220, light for providing the image for viewing by the user may be emitted from the front surface 220_FS. A first multi-channel lens 231 and a second multi-channel lens 232 may be disposed on the front surface 220_FS of the display unit 220. A plurality of camera sensors may be disposed on the rear surface 220_RS of the display unit 220. However, the present disclosure is not limited thereto, and the plurality of camera sensors may be disposed in the lens unit 230, the main frame 210, the cover frame 240, and the like.

The display unit 220 may be fixed to the main frame 210, and in one embodiment may be detachably provided. The display unit 220 may be configured to be opaque, transparent or translucent according, for example, to the type of the display device 200. The display unit 220 may include an electronic component (e.g., a display module including a display panel) or a display device such as a mobile terminal including a display panel. However, the present disclosure is not limited thereto. For example, the display unit 220 may include a micro display.

The display unit 220 may include a display panel for image display. The display panel may be a light emitting display panel including a light emitting element. For example, the display panel may include an organic light emitting display panel using an organic light emitting diode including an organic emission layer, a micro light emitting diode (LED) display panel using a micro LED, a quantum dot light emitting display panel using a quantum dot light emitting diode including a quantum dot emission layer, or an inorganic light emitting display panel using an inorganic light emitting diode including an inorganic semiconductor.

The lens unit 230 may allow light emitted from the display unit 220 to pass therethrough, to thereby provide the light to the user. The lens unit 230 may have a plurality of channels for allowing light emitted from the display unit 220 to pass therethrough. The plurality of channels may allow light emitted from the display unit 220 to pass therethrough along different paths, thereby proving the light to the user. The light emitted from the display unit 220 may be incident into each channel to generate an enlarged image focused on eyes of the user.

The lens unit 230 may include a plurality of lenses corresponding to a focus optical system. In an embodiment, the lens unit 230 may include the first multi-channel lens 231 corresponding to one eye of the user and the second multi-channel lens 232 corresponding to the other eye of the user. The multi-channel lenses 231 and 232 are exemplified as the focus optical system disposed between the eyes of the user and the front surface 220_FS of the display unit 220, but the present disclosure is not limited thereto. For example, the focus optical system may include various kinds of lenses such as a convex lens, a concave lens, a spherical lens, an aspherical lens, a single lens, a complex lens, a standard lens, a narrow angle lens, a wide angle lens, a fixed focus lens, a variable focus lens, a pancake lens, or a combination thereof.

As shown in FIG. 6, the first multi-channel lens 231 and the second multi-channel lens 232 may be disposed on the front surface 220_FS of the display unit 220. The first multi-channel lens 231 and the second multi-channel lens 232 may be arranged on the front surface 220_FS of the display unit 220 corresponding to the positions of the left and right eyes of the user, respectively. The first multi-channel lens 231 and the second multi-channel lens 232 may be accommodated in the main frame 210.

The first multi-channel lens 231 and the second multi-channel lens 232 may reflect and/or refract light for providing an image displayed on the display unit 220 to the user in the form of a virtual reality image.

The cover frame 240 may be disposed on the rear surface 220_RS of the display unit 220 to protect the display unit 220.

Referring to FIG. 7, the display device 200 in accordance with the embodiment of the present disclosure may include a cover frame 240, a lens unit (or lens arrangement) 230 located on the cover frame 240, and a display unit (or display) 220 located between the cover frame 240 and the lens unit 230.

The display unit 220 may include a first display unit 221 overlapping with a first multi-channel lens 231 and a second display unit 222 overlapping with a second multi-channel lens 232. The lens unit 230 may include the first multi-channel lens 231 corresponding to the left eye of the user and the second multi-channel lens 232 corresponding to the right eye of the user.

The first multi-channel lens 231 may include two first sub-areas Ra and two second sub-areas Rb, which are divided along a first direction DR1 and a second direction DR2 with respect to a first central part CL.

One first sub-area Ra and one second sub-area Rb of the first multi-channel lens 231 may be located along a diagonal which passes through the first central part CL and which forms a predetermined angle (e.g., about 45 degrees or another angle) with the first direction DR1 and the second direction DR2.

The first multi-channel lens 231 may be divided into four areas (or quadrants) with respect to a cross-shaped virtual line passing through the first central part CL, and the two first sub-areas Ra and the two second sub-areas Rb may be located in corresponding ones of the four areas.

The first multi-channel lens 231 may include a plurality of sub-lenses. In an embodiment, the first multi-channel lens 231 may include four sub-lenses SL11, SL12, SL13, and SL14. However, the number of sub-lenses included in the first multi-channel lens 231 is not limited to four as in the case in the above-described example.

The first multi-channel lens 231 may have a predetermined (e.g., an approximately circular) shape on a plane. The plurality of sub-lenses SL11, SL12, SL13, and SL14 may be disposed to surround the center of the above-described circular shape on a plane. For example, a first sub-lens SL11, a second sub-lens SL12, a third sub-lens SL13, and a fourth sub-lens SL14 may be respectively disposed at a left upper end, a right upper end, a left lower end, and a right lower end with respect to the first central part CL. Thus, the first sub-lens SL11 and the third sub-lens SL13 may be disposed in the first sub-areas Ra, and the second sub-lens SL12 and the fourth sub-lens SL14 may be disposed in the second sub-areas Rb. The plurality of sub-lenses SL11, SL12, SL13, and SL14 may be integrally connected to each other, and be separated from each other.

An image of the first display unit 221 corresponding to the two first sub-areas Ra and the two second sub-areas Rb may be refracted toward the first central part CL of the first multi-channel lens 231 while passing through the first multi-channel lens 231.

The second multi-channel lens 232 may include two first sub-areas Ra and two second sub-areas Rb, which are divided along the first direction DR1 and the second direction DR2 with respect to a second central part CR.

One first sub-area Ra and one second sub-area Rb of the second multi-channel lens 232 may be located along a diagonal which passes through the second central part CR and forms a predetermined angle (e.g., about 45 degrees) with the first direction DR1 and the second direction DR2.

The second multi-channel lens 232 may be divided into four areas (or quadrants) with respect to a cross-shaped virtual line passing through the second central part CR, and the two first sub-areas Ra and the two second sub-areas Rb may be located in corresponding ones of the four areas.

The second multi-channel lens 232 may include a plurality of sub-lenses. In an embodiment, the second multi-channel lens 232 may include four sub-lenses SL21, SL22, SL23, and SL24. However, the number of sub-lenses included in the second multi-channel lens 232 is not limited to four as in the above-described example.

The second multi-channel lens 232 may have a predetermined (e.g., an approximately circular) shape on a plane. The plurality of sub-lenses SL21, SL22, SL23, and SL24 may be disposed to surround the center of the above-described circular shape on a plane. For example, a fifth sub-lens SL21, a sixth sub-lens SL22, a seventh sub-lens SL23, and an eighth sub-lens SL24 may be respectively disposed at a left upper end, a right upper end, a left lower end, and a right lower end with respect to the second central part CR. Thus, the fifth sub-lens SL21 and the seventh sub-lens SL23 may be disposed in the first sub-areas Ra, and the sixth sub-lens SL22 and the eighth sub-lens SL24 may be disposed in the second sub-areas Rb. The plurality of sub-lenses SL21, SL22, SL23, and SL24 may be integrally connected to each other, and be separated from each other.

An image of the second display unit 222 corresponding to the two first sub-areas Ra and the two second sub-areas Rb may be refracted toward the second central part CR of the second multi-channel lens 232 while passing through the second multi-channel lens 232. Hereinafter, a change in direction of an image passing through the first and second sub-areas Ra and Rb will be described.

Referring to FIGS. 7 and 8, the lens unit 230 may include a first boundary part S1, a second boundary part S2, and a third boundary part S3 which are sequentially located along a direction facing an eye UEE of the user from the display unit 220. The first boundary part S1 may a flat first surface of the lens unit 230 which faces the display unit 220. The third boundary part S3 may be a second surface of the lens unit 230 which faces the eye UEE of the user. The second boundary part S2 may be a surface of an intermediate portion which is located between the first boundary part S1 and the third boundary part S3 and is inclined to form a slope with the first boundary part S1 in the lens unit 230. The distance between the second boundary part S2 and the third boundary part S3 may be narrower than the distance between the first boundary part S1 and the second boundary part S2 at a central part C of the lens unit 230. The distance between the second boundary part S2 and the third boundary part S3 may gradually become wider and then become narrower again as approaching an edge from the central part C.

Shapes of the lens unit 230, which are located in the first sub-area Ra and the second sub-area Rb, may be symmetrical to each other with respect to the central part C of the lens unit 230.

Light Lr0 emitted from the display unit 220 may be refracted at the second boundary part S2 while passing through the first boundary part S1 of the lens unit 230. First refracted light Lr1 which undergoes a change in direction may be reflected at the third boundary part S3 of the lens unit 230 in a direction facing toward the central part of the lens unit 230. Through this lens arrangement, the direction of the first refracted light Lr1 may be changed to be more distant from the eye UEE of the user.

The first reflected light Lr2 may be re-reflected at the second boundary part S2 of the lens unit 230. As a result, the direction of the first reflected light Lr2 is changed to be closer to the central part of the lens unit 230 and to be closer to the eye UEE of the user. The second reflected light Lr3, which has undergone a direction change, may be refracted at a surface of the lens unit 230. The second refracted light Lr4, which is refracted at the surface of the lens unit 230, may be emitted to face the eye UEE of the user.

As such, the lens unit 230 has two first sub-areas Ra and two second sub-area Rb which are symmetrical to each other with respect to the central part C. The lens unit 230 located in each first sub-area Ra and each second sub-area Rb has different distances and different thicknesses, such that distances between the first to third boundary parts S1, S2, and S3 are changed at different positions. Accordingly, the direction of the light Lr0 emitted from the display unit 220 to the lens unit 230 is changed to face toward the eye UEE of the user. The light Lr0 is refracted to form the first refracted light Lr1, which is reflected to form the first reflected light Lr2, which is reflected to form the second reflected light Lr3, which is refracted to form the second refracted light Lr4, thereby displaying a three-dimensional image (or VR image).

FIG. 9 is a block diagram illustrating a display device 200 in accordance with an embodiment of the present invention. In relation to FIG. 9, descriptions of portions overlapping with those described above will be omitted or simplified.

Referring to FIG. 9, the display device 200 may include a display unit (or display) 220, a lens unit (or lens arrangement) 230, and a control unit (or controller) 250.

The display unit 220 includes a plurality of pixels that emit light for displaying an image IM. The display unit 220 may display the image IM based on mapping data MD provided from the control unit 250.

The lens unit 230 may provide a VR image VR by refracting and reflecting the image IM displayed on the display unit 220. As described above, the lens unit 230 may include multi-channel lenses 231 and 232 (e.g., see FIG. 6) for providing the VR image VR.

The control unit 250 may control overall operation of the display device 200. The control unit 250 may be implemented, for example, as a dedicated processor including an embedded processor or the like and/or a general-purpose processor including a central processing unit, an application processor, or the like. However, the present disclosure is not limited thereto.

A mapping function MF may be provided to the control unit 250. Alternatively, the mapping function MF may be pre-stored in the control unit 250. The mapping function MF is extracted from the above-described mapping function extraction system 100 (e.g., see FIG. 1), and may be a correction function for preventing distortion of the VR image VR. For example, a difference value between standard appearance data RAD (see FIG. 1) and appearance data AD (see FIG. 1) of the multi-channel lenses 231 and 232 (see FIG. 6) included in the lens unit 230 may be applied to the mapping function MF. The standard appearance data RAD and the appearance data AD are the same as described above.

VR image data VRD may be provided to the control unit 250. Alternatively, the VR image data VRD may be pre-stored in the control unit 250. The VR image data VRD may include information on the VR image VR to be provided, e.g., the VR image VR having no distortion.

The control unit 250 may generate mapping data MD based on the mapping function MF and the VR image data VRD. The mapping data MD includes position information of pixels corresponding to the VR image VR. For example, the control unit 250 may process, in a data form, an arrangement characteristic of pixels of the image IM to be displayed on the display unit 220 so as to provide the VR image VR, based on the mapping function MF and the VR image data VRD. As such, since the control unit 250 performs a mapping process (based on the mapping function MF on which appearance information of the multi-channel lenses 231 and 232 (see FIG. 6) included in the lens unit 230 is pre-reflected), it is unnecessary to perform a separate process (e.g., image photographing or the like) for extracting the mapping function MF, so that a time for performing the mapping process can be significantly reduced. In addition, the control unit 250 can effectively prevent distortion of the VR image VR according to a characteristic of the multi-channel lenses 231 and 232 included in the lens unit 230. The control unit 250 may provide the mapping data MD to the display unit 220.

In accordance to one or more of the aforementioned embodiments of the present invention, a mapping function for preventing distortion of a VR image can be rapidly extracted or determined. In accordance to one or more of the aforementioned embodiments of the present invention, the time for performing a mapping process can be shortened and distortion of a VR image can be effectively prevented.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

For example, in accordance with one embodiment, a computer-readable medium stores instructions which, when executed by at least one processor, causes the at least one processor to: generate appearance data of a multi-channel lens by scanning the multi-channel lens; generate correction data by comparing the appearance data with pre-stored standard appearance data; and generate a mapping function by applying the correction data to a pre-stored standard mapping function. The computer-readable medium may be included, for example, in the display device 200 of FIG. 9. In one embodiment, the computer-readable medium may be coupled to the controller as previously described herein.

The controllers, processors, devices, modules, units, and other signal generating and signal processing features of the embodiments disclosed herein may be implemented, for example, in non-transitory logic that may include hardware, software, or both. When implemented at least partially in hardware, the controllers, processors, devices, modules, units, and other signal generating and signal processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, devices, modules, units, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Although the present invention has been specifically described according to the above-described embodiments, it should be noted that the above-described embodiments are intended to illustrate the present invention and not to limit the scope of the present invention. Those of ordinary skill in the art to which the present invention pertains will understand that various modifications are possible within the scope of the technical spirit of the present invention.

Therefore, the technical protection scope of the present invention is not limited to the detailed description described in the specification, but should be determined by the appended claims. In addition, all changes or modifications derived from the meaning and scope of the claims and their equivalents should be construed as being included in the scope of the present invention. The embodiments may be combined to form additional embodiments.

What is claimed is:

1. A mapping function extraction system comprising:
a scanner configured to generate appearance data of a multi-channel lens by scanning the multi-channel lens;
a comparator configured to generate correction data by comparing the appearance data with pre-stored standard appearance data; and
an extractor configured to generate a mapping function by applying the correction data to a pre-stored standard mapping function.

2. The mapping function extraction system of claim 1, wherein the multi-channel lens includes a plurality of sub-lenses through which light emitted from a display passes.

3. The mapping function extraction system of claim 2, wherein the appearance data includes appearance information of a recessed part formed by the plurality of sub-lenses.

4. The mapping function extraction system of claim 1, wherein the standard appearance data includes appearance information of the multi-channel lens having an ideal design.

5. The mapping function extraction system of claim 1, wherein the correction data is derived based on a difference between the standard appearance data and the appearance data.

6. The mapping function extraction system of claim 1, wherein the standard mapping function is to calculate position information of pixels corresponding to a virtual reality image to be provided through the multi-channel lens that is ideally designed.

7. The mapping function extraction system of claim 1, wherein the mapping function is extracted based on a change in the appearance data.

8. A mapping function extraction method comprising:
generating appearance data of a multi-channel lens by scanning the multi-channel lens;
generating correction data by comparing the appearance data with pre-stored standard appearance data; and
extracting a mapping function by applying the correction data to a pre-stored standard mapping function.

9. The mapping function extraction method of claim 8, wherein the multi-channel lens includes a plurality of sub-lenses through which light emitted from a display passes.

10. The mapping function extraction method of claim 9, wherein the appearance data includes appearance information of a recessed part formed by the plurality of sub-lenses.

11. The mapping function extraction method of claim 8, wherein the standard appearance data includes appearance information of the multi-channel lens having an ideal design.

12. The mapping function extraction method of claim 8, wherein the correction data is derived based on a difference between the standard appearance data and the appearance data.

13. The mapping function extraction method of claim 8, wherein the standard mapping function is to calculate position information of pixels corresponding to a virtual reality image to be provided through the multi-channel lens that is ideally designed.

14. The mapping function extraction method of claim 8, wherein the mapping function is extracted based on a change in the appearance data.

15. A display device comprising:
a display including pixels;
a lens arrangement including at least one multi-channel lens configured to provide a virtual reality (VR) image by refracting and reflecting an image displayed on the display; and
a controller configured to generate mapping data including position information of the pixels corresponding to the VR image, based on a pre-stored mapping function and VR image data, wherein a difference value between standard appearance data of the multi-channel lens and appearance data of the multi-channel lens is applied to the mapping function.

16. The display device of claim 15, wherein the mapping function is extracted based on a change in the appearance data.

17. The display device of claim 15, wherein the standard appearance data includes appearance information of the multi-channel lens having an ideal design.

18. The display device of claim 15, wherein the appearance data includes appearance information of the multi-channel lens through scanning.

19. The display device of claim 15, wherein the appearance data includes appearance information of a recessed part formed by a plurality of sub-lenses included in the multi-channel lens.

20. The display device of claim 15, wherein:
the controller is configured to provide the mapping data to the display, and
the display is configured to display the image based on the mapping data.

21. A computer-readable medium storing instructions which, when executed by at least one processor, causes the at least one processor to:
generate appearance data of a multi-channel lens by scanning the multi-channel lens;
generate correction data by comparing the appearance data with pre-stored standard appearance data; and
generate a mapping function by applying the correction data to a pre-stored standard mapping function.
